(19) United States
(12) Patent Application Publication
(10) Pub. No.: US 2025/0272340 A1
(43) Pub. Date: Aug. 28, 2025

(54) INFORMATION PROCESSING DEVICE, INFORMATION PROCESSING METHOD, AND NON-TRANSITORY COMPUTER-READABLE STORAGE MEDIUM

(71) Applicant: HONDA MOTOR CO., LTD., MINATO-KU, TOKYO (JP)

(72) Inventors: Shiori MOCHIDA, MINATO-KU, TOKYO (JP); Yukako TAKAHASHI, MINATO-KU, TOKYO (JP); Hisaki YANAGISAWA, MINATO-KU, TOKYO (JP); Takeshi MITSUI, MINATO-KU, TOKYO (JP)

(21) Appl. No.: 18/723,513

(22) PCT Filed: Dec. 21, 2022
(86) PCT No.: PCT/JP2022/047069

§ 371 Date: Jun. 24, 2024

(30) Foreign Application Priority Data
Dec. 27, 2021 (JP) 2021-212101

(51) Int. Cl. G06F 16/951; G06F 40/279; G06Q 50/18

(52) U.S. Cl. CPC G06F 16/951; G06F 40/279; G06Q 50/18

(57) ABSTRACT

An information processing device comprises: a keyword extraction unit that extracts a keyword from acquired information; an analysis target trend data generation unit that generates analysis target trend data quantitatively indicating the trend of an analysis target keyword by analyzing the trend of the analysis target keyword from a predetermined viewpoint; and a specific keyword determination unit that, on the basis of the analysis target trend data and past case trend data on past case keywords concerning past cases in which laws or standards were established or revised, determines whether or not the analysis target keyword corresponds to a specific keyword which can be used for predicting the trend of establishment or revision of a law or a standard.

### TECHNICAL FIELD

The present invention relates to an information processing device, an information processing method, and a program.

### BACKGROUND ART

In JP 2004-110149 A, a regulatory information management system that can promptly provide customers with product data in accordance with legal revisions is disclosed.

### SUMMARY OF THE INVENTION

However, the system disclosed in JP 2004-110149 A can only provide customers with product data in response to legal revisions. There is a long awaited need for a technology that is capable of more satisfactorily coping with the enactment or revision of laws and regulations or the like.

The present invention has the object of solving the aforementioned problem.

An information processing device according to one aspect of the present invention comprises an information acquisition unit configured to acquire information from a website at intervals, a keyword extraction unit configured to extract a keyword from the information acquired by the information acquisition unit, an analysis target trend data generation unit which, by analyzing from a predetermined perspective a trend of an analysis target keyword which is a keyword that serves as a target of trend analysis, is configured to generate analysis target trend data indicating a trend of the analysis target keyword, and a specific keyword determination unit configured to determine, based on past case trend data obtained by analyzing from the perspective a past case keyword, which is a keyword related to a past case that led to the enactment or revision of laws and regulations or standards, and the analysis target trend data, whether or not the analysis target keyword corresponds to a specific keyword that can be used to predict a trend in the establishment or revision of the laws and regulations or standards.

An information processing method according to another aspect of the present invention comprises an acquisition step of acquiring information from a website at intervals, a keyword extraction step of extracting a keyword from the information acquired in the acquisition step, an analysis target trend data generation step of generating, by analyzing from a predetermined perspective a trend of an analysis target keyword which is a keyword that serves as a target of trend analysis, analysis target trend data indicating a trend of the analysis target keyword, and a specific keyword determination step of determining, based on past case trend data obtained by analyzing from the perspective a past case keyword, which is a keyword related to a past case that led to the enactment or revision of laws and regulations or standards, and the analysis target trend data, whether or not the analysis target keyword corresponds to a specific keyword that can be used to predict a trend in the establishment or revision of the laws and regulations or standards.

A program according to still another aspect of the present invention causes a computer to perform an acquisition step of acquiring information from a website at intervals, a keyword extraction step of extracting a keyword from the information acquired in the acquisition step, an analysis target trend data generation step of generating, by analyzing from a predetermined perspective a trend of an analysis target keyword which is a keyword that serves as a target of trend analysis, analysis target trend data indicating a trend of the analysis target keyword, and a specific keyword determination step of determining, based on past case trend data obtained by analyzing from the perspective a past case keyword, which is a keyword related to a past case that led to the enactment or revision of laws and regulations or standards, and the analysis target trend data, whether or not the analysis target keyword corresponds to a specific keyword that can be used to predict a trend in the establishment or revision of the laws and regulations or standards.

According to the present invention, it becomes possible to more satisfactorily cope with the enactment or revision of the laws and regulations or the like.

### BRIEF DESCRIPTION OF DRAWINGS

FIG. 1 is a block diagram showing an information processing device according to one embodiment;

FIG. 2 is a flowchart illustrating an information processing method according to the one embodiment; and

FIG. 3 is a flowchart illustrating the information processing method according to the one embodiment.

### DETAILED DESCRIPTION OF THE INVENTION

### Embodiment

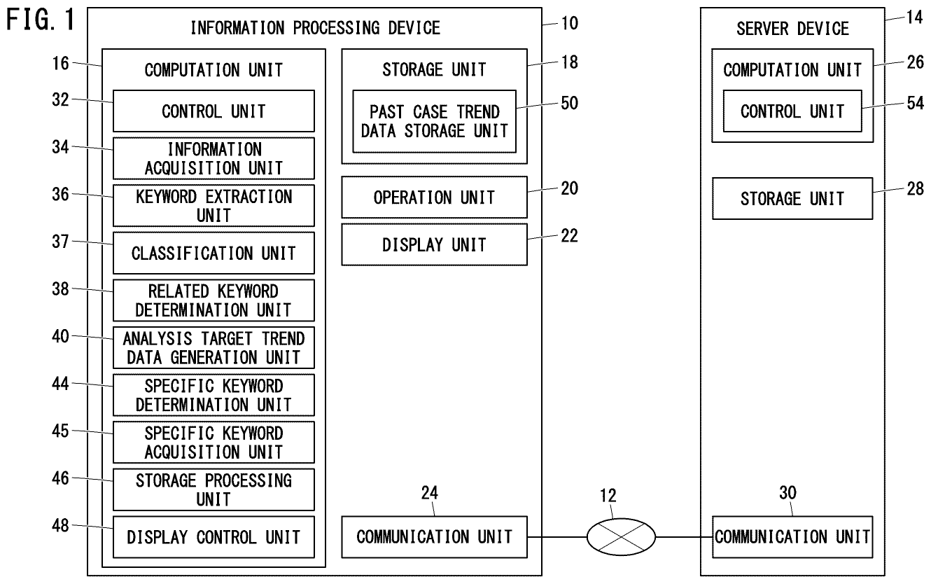

A description will be given with reference to FIG. 1 to FIG. 3 concerning an information processing device, an information processing method, and a program according to one embodiment. FIG. 1 is a block diagram showing the information processing device according to a present embodiment.

An information processing device 10 according to the present embodiment is capable of communicating with a server device 14 via a network 12 such as the Internet or the like. In FIG. 1, one server device 14 from among a plurality of server devices 14 is shown.

The information processing device 10 can be equipped with a computation unit 16, a storage unit 18, an operation unit 20, a display unit 22, and a communication unit 24. Although the information processing device 10 can also be equipped with other constituent elements apart from these constituent elements, description of such other elements will be omitted herein.

The server device 14, for example, is a Web server. A website can be built in the server device 14. The server device 14 may be equipped with a computation unit 26, a storage unit 28, and a communication unit 30. Although the server device 14 may comprise constituent elements other than these constituent elements, description of such other elements is omitted herein.

As noted previously, the information processing device 10 may be equipped with the computation unit 16. The computation unit 16 may be constituted by a processor, and more specifically, a processing circuit (processing circuitry) such as a CPU (Central Processing Unit), a GPU (Graphics Processing Unit), or the like. The computation unit 16 may be equipped with a control unit 32, an information acquisition unit 34, a keyword extraction unit 36, a classification unit 37, a related keyword determination unit 38, an analysis target trend data generation unit 40, a specific keyword determination unit 44, a specific keyword acquisition unit 45, a storage processing unit 46, and a display control unit 48. The control unit 32, the information acquisition unit 34, the keyword extraction unit 36, the classification unit 37, the related keyword determination unit 38, the analysis target trend data generation unit 40, the specific keyword determination unit 44, the specific keyword acquisition unit 45, the storage processing unit 46, and the display control unit 48 can be realized by the computation unit 16 executing a program that is stored in the storage unit 18. Moreover, it should be noted that, although the computation unit 16 may comprise constituent elements other than these constituent elements, description of such other elements is omitted herein.

Moreover, at least a portion of the control unit 32, the information acquisition unit 34, the keyword extraction unit 36, the classification unit 37, the related keyword determination unit 38, the analysis target trend data generation unit 40, the specific keyword determination unit 44, the specific keyword acquisition unit 45, the storage processing unit 46, and the display control unit 48 may be realized by an integrated circuit such as an ASIC (Application Specific Integrated Circuit), an FPGA (Field-Programmable Gate Array), or the like. Further, at least a portion of the control unit 32, the information acquisition unit 34, the keyword extraction unit 36, the classification unit 37, the related keyword determination unit 38, the analysis target trend data generation unit 40, the specific keyword determination unit 44, the specific keyword acquisition unit 45, the storage processing unit 46, and the display control unit 48 may be constituted by an electronic circuit including a discrete device.

As noted previously, the information processing device 10 may be equipped with the storage unit 18. The storage unit 18 may comprise a non-illustrated volatile memory and a non-illustrated non-volatile memory. As the volatile memory, there may be cited, for example, a RAM (Random Access Memory). The volatile memory is used as a working memory of a processor, and temporarily stores data or the like required for processing or calculations. As the non-volatile memory, there may be cited, for example, a ROM (Read Only Memory), a flash memory, or the like. The non-volatile memory is used as a storage memory, and stores therein programs, tables, maps, and the like. At least a portion of the storage unit 18 may be provided in the processor, the integrated circuit, or the like, which were described above. Further, the storage unit 18 may further be equipped with an HDD (Hard Disk Drive), an SSD (Solid State Drive), or the like. An application program for causing a computer to execute the information processing method according to the present embodiment is installed beforehand in the storage unit 18. Further, the storage unit 18 may also be provided with a past case trend data storage unit 50 in which there is stored past case trend data, which will be described later. At least a portion of the storage unit 18 may be constituted by a non-illustrated storage device that is provided separately from the information processing device 10. As such a storage device, there may be cited, for example, a storage of the Amazon Web Service (AWS) or the like, although the present invention is not necessarily limited to this feature.

As noted previously, the information processing device 10 may be equipped with the operation unit 20. The operation unit 20 can be used when the user performs an operation input with respect to the information processing device 10. As the operation unit 20, there may be cited a keyboard, a mouse, or the like, although the present invention is not necessarily limited to this feature.

As noted previously, the information processing device 10 may be equipped with the display unit 22. A non-illustrated display element may be provided in the display unit 22. As such a display element, there may be used, for example, a liquid crystal display element, an organic electroluminescence display element, or the like. The operation unit 20 and the display unit 22 may be constituted by a non-illustrated touch panel that is equipped with such a display element.

As noted previously, the information processing device 10 may be equipped with the communication unit 24. The communication unit 24, for example, is equipped with a non-illustrated communication module. The communication unit 24 is capable of carrying out, via the network 12, communications with the communication unit 30 that is provided in the server device 14.

As noted previously, the server device 14 may be equipped with the computation unit 26. The computation unit 26 may be constituted by a processor, and more specifically, processing circuitry such as a CPU, a GPU, or the like. The computation unit 26 may be equipped with a control unit 54. The control unit 54 administers the control of the server device 14 as a whole. The control unit 54 can be realized by a program that is stored in the storage unit 28 being executed by the computation unit 26. Moreover, it should be noted that, although the computation unit 26 may comprise constituent elements other than the control unit 54, description of such other elements is omitted herein.

Moreover, at least a portion of the control unit 54 may be realized by an integrated circuit such as an ASIC, an FPGA, or the like. Further, at least a portion of the control unit 54 may be constituted by an electronic circuit including a discrete device.

As noted previously, the server device 14 may be equipped with the storage unit 28. The storage unit 28 may comprise a non-illustrated volatile memory and a non-illustrated non-volatile memory. Further, the storage unit 28 may further be equipped with an HDD, an SSD, or the like. As noted previously, the website is built in the server device 14. Page data that constitutes a web page can be stored in the storage unit 28. Textual information may be included in the web page.

As noted previously, the information processing device 10 may be equipped with the control unit 32. The control unit 32 administers the control of the information processing device 10 as a whole.

As noted previously, the information processing device 10 may be equipped with the information acquisition unit 34. The information acquisition unit 34 acquires information from a specified site, which is a website specified in advance by a user. More specifically, the information acquisition unit 34 acquires text information from the specified site. Only one website may be specified as the specified site, or a plurality of websites may be designated as the specified site.

As such a specified site, for example, there may be cited a popular website, a specialized website, a national policy website or the like, although the present invention is not necessarily limited to this feature. As the popular website, for example, there may be cited a news site or the like, although the present invention is not necessarily limited to this feature. As the specialized website, for example, there may be cited a website of a professional organization or the like, although the present invention is not necessarily limited to this feature. As the national policy website, for example, there may be cited a website of a political party, and a website of a government agency or the like, although the present invention is not necessarily limited to this feature. Moreover, it should be noted that the information acquisition unit 34 may appropriately acquire information from an unspecified site, which is a website other than the websites that have been specified in advance by the user.

A general process by which the regulations or standards are established or revised is as follows. Specifically, in a first stage, interest in a case or a circumstance arises. In the first stage, such a case or a circumstance becomes topical. In the first stage, the case is typically reported by a general information source. As the general information source, for example, there may be cited the press or a news organization or the like, although the present invention is not necessarily limited to this feature. In the first stage, the case may be reported, for example, on a popular or widely known website. Specifically, in the first stage, the case may be reported on the website of a news organization or the like. In the first stage, the case also becomes in a state of being reported by a specialized information source. Specifically, in the first stage, the case also becomes in a state of being reported, for example, by a specialized institution. More specifically, in the first stage, the case becomes in a state of being reported, for example, from a website or the like of the specialized institution. In the second stage, such a case becomes a social problem. Further, in the second stage, technological advances will occur in order to resolve such a case. In the third stage, such a case becomes an agenda item for a meeting or the like. In the third stage, such a case also becomes in a state of being reported by a political party, a government agency, or the like. More specifically, in the third stage, such a case becomes in a state of being reported, for example, from a website or the like of the political party, the government agency, or the like. In the fourth stage, establishment or revision of the laws and regulations or standards is carried out. More specifically, in the fourth stage, such a case becomes in a state of being reported, for example, from a website that provides information of the laws and regulations, and information of the standards, or the like. Since the laws and regulations or standards are established or revised through the processes described above, the acquisition of the information from the specified site in the manner described above contributes to the acquisition of specific keywords to be described later which can be used to predict trends in the establishment or revision of the laws and regulations or standards. In the present specification, the term laws and regulations is intended to be broadly interpreted, and is not necessarily limited to statutes. Moreover, it should be noted that the term statutes is a general term for legislation (legal norms enacted by a legislative assembly) and orders (legal norms enacted by administrative agencies).

The information acquisition unit 34 acquires such information at intervals. The information acquisition unit 34 acquires such information, for example, periodically. The information acquisition unit 34 acquires such information, for example, once every week, although the present invention is not necessarily limited to this feature. The information acquisition unit 34 may acquire such information every day, or may acquire such information once every month. Further, the information acquisition unit 34 may also acquire such information at an irregular interval.

As noted previously, the information processing device 10 may be equipped with the keyword extraction unit 36. The keyword extraction unit 36 extracts a keyword from the acquired information, which is information acquired by the information acquisition unit 34. Extraction of the keyword can be performed in the following manner. First, the keyword extraction unit 36 divides into words the text information acquired by the information acquisition unit 34. Next, the keyword extraction unit 36 extracts a keyword from among the plurality of words obtained by the division. Extraction of the keyword can be performed, for example, in the following manner. Specifically, in extracting the keyword, an independent word is extracted as the keyword, however, a dependent word is not extracted as the keyword. An independent word is a word that is capable of making up a phrase on its own. A dependent word is a word that is incapable of making up a phrase on its own, but rather, is a word that is appended to an independent word to thereby make up a phrase. The method of extracting the keyword is not necessarily limited to the foregoing. In this manner, the keyword is extracted from among the information acquired by the information acquisition unit 34. Moreover, in the case it is necessary for translation to be performed with respect to the text information acquired by the information acquisition unit 34, the keyword extraction unit 36 performs such translation of the text information prior to the text information having been divided into words. At least a portion of the keyword extraction unit 36 is capable of using artificial intelligence (AI).

As noted previously, the information processing device 10 may be equipped with the classification unit 37. The classification unit 37 determines whether or not the keyword extracted by the keyword extraction unit 36 belongs to any one from within a plurality of fields that are divided in advance. As such fields, there may be cited, for example, politics, economics, industry, technology, entertainment, and the like, although the present invention is not necessarily limited to this feature. The classification unit 37 associates with the keyword information indicating the field to which the keyword belongs. At least a portion of the classification unit 37 is capable of using artificial intelligence.

As noted previously, the information processing device 10 may be equipped with the related keyword determination unit 38. The related keyword determination unit 38 determines related keywords that are related to the keyword. The related keyword determination unit 38 determines keywords whose relationship with respect to a certain keyword is comparatively high as being related keywords of the certain keyword. The related keyword determination unit 38 does not determine keywords whose relationship with respect to a certain keyword is comparatively low as being related keywords of the certain keyword.

The related keyword determination unit 38 determines the related keywords in the following manner. Specifically, in the case that a plurality of keywords exist within a sentence, these keywords are associated with one another. The related keyword determination unit 38 is capable of determining a relationship between the keywords themselves based on, for example, a number of times that the association between the keywords appears within the same document. For example, the number of times that the keywords themselves are associated with each other can be used as a value that indicates a highness of the relationship, although the present invention is not necessarily limited to this feature.

A description will be given of an example in which the following sentence (a first sentence) exists within the document. The first sentence, for example, is a sentence that says “I like dogs.” The keywords extracted from the first sentence are “I,” “dogs,” and “like.” Since the keywords “I,” “dogs,” and “like” exist within the first sentence, “I,” “dogs,” and “like” are associated with each other. When only one first sentence is considered, the number of times that these keywords themselves are associated with each other is one time.

Within the document, not only the first sentence, but also a second sentence exists. In the case that a common keyword exists in both the first sentence and the second sentence, the related keyword determination unit 38 focuses attention on both the first sentence and the second sentence. The second sentence, for example, is a sentence that says “I also like cats.” The keywords extracted from the second sentence are “I,” “cats,” and “like.” The first sentence and the second sentence have in common the point that they both contain the word “I.” Further, the first sentence and the second sentence have in common the point that they both contain the word “like.” Accordingly, the related keyword determination unit 38 focuses attention on both the first sentence and the second sentence. Since the keywords “I,” “cats,” and “like” exist within the second sentence, the keywords “I,” “cats,” and “like” are associated with each other. In the case that attention is focused on both the first sentence and the second sentence, the number of times that the keywords themselves are associated with each other is as follows. The total number of times that the association between “I” and “like” appears is two times. The total number of times that “I” and “dog” are associated with each other is one time. The number of times that “I” and “cat” are associated with each other is one time. The total number of times that the association between “dog” and “like” appears is 1 time. The total number of times that the association between “cat” and “like” appears is 1 time. The total number of times that the association between “dog” and “cat” appears is 0 times.

A large number of sentences exist within the document. The related keyword determination unit 38, by focusing attention on the large number of sentences contained within the acquired information, determines the relationship between the keywords themselves. The related keyword determination unit 38 determines keywords whose relationship with respect to a certain keyword is greater than or equal to a relationship threshold value as being related keywords of the certain keyword. For example, in the case that the number of times that the association between “I” and “like” appears, for example, is 10 times, and the relationship threshold value, for example, is 5, the relationship of the word “like” with respect to the word “I” is greater than or equal to the relationship threshold value. Accordingly, in such a case, the related keyword determination unit 38 determines that the word “like” is a related keyword of the word “I.” In such a case, the relationship of the word “I” with respect to the word “like” is also greater than or equal to the relationship threshold value. Accordingly, the related keyword determination unit 38 determines that the word “I” is a related keyword of the word “like.” Moreover, in this instance, although a case has been described as an example in which the relationship threshold value is set, the present invention is not necessarily limited to this feature. The relationship threshold value need not necessarily be set.

The related keyword determination unit 38 does not determine keywords whose relationship with respect to a certain keyword is less than the relationship threshold value as being related keywords of the certain keyword. For example, in the case that the number of times that the association between “I” and “dog” appears is 3 times, and the relationship threshold value is 5, the relationship of the word “dog” with respect to the word “I” is less than the relationship threshold value. Accordingly, in such a case, the related keyword determination unit 38 does not determine that the word “dog” is a related keyword of the word “I.” In such a case, the relationship of the word “dog” with respect to the word “I” is also less than the relationship threshold value. Accordingly, the related keyword determination unit 38 does not determine that the word “I” is a related keyword of the word “dog.”

In this manner, the related keyword determination unit 38 determines related keywords that are related to the keyword. Artificial intelligence may be used in at least a portion of the related keyword determination unit 38.

The related keyword determination unit 38 stores in association with each other in the storage unit 18 the keyword, and the related keywords of the keyword.

As noted previously, the information processing device 10 may be equipped with the analysis target trend data generation unit 40. The analysis target trend data generation unit 40 analyzes a trend of the analysis target keyword (analytical-study target keyword) from predetermined perspectives (indexes). The analysis target keyword is a keyword that becomes a target of trend analysis (analytical study of the trend). The analysis target trend data generation unit 40, by analyzing the trend of the analysis target keyword from the predetermined perspectives, is capable of generating the analysis target trend data that quantitatively indicates the trend of the analysis target keyword.

As the concerned perspectives, there may be cited the following first perspective, the second perspective, the third perspective, and the fourth perspective.

The first perspective (first index), for example, is an elapsed period. The elapsed period is a period from the analysis target keyword having begun to appear within the acquired information. Specifically, the elapsed period is a period from the analysis target keyword having begun to appear in the specified site.

The first aspect may be a continuous appearance period. The continuous appearance period is a period during which the analysis target keyword appears continuously within the acquired information.

The second perspective (second index), for example, is a change over time in a number of appearances. The number of appearances is a number of the analysis target keywords that have appeared within the acquired information. The number of appearances is a number of the analysis target keywords that are included within the acquired information obtained at the current time. The number of appearances of the analysis target keyword contained within the acquired information obtained at a previous time and earlier is not included in the current number of appearances. The change over time in the number of appearances can be interpreted broadly. Specifically, the change over time in a rate of increase in the number of appearances may also be included within the meaning of the change over time in the number of appearances.

The third perspective (third index), for example, is a change over time in a number of the related keywords. The number of the related keywords is a number of the related keywords that are related to the analysis target keyword. The change over time in the number of related keywords can be interpreted broadly. Specifically, the change over time in a rate of increase in the number of related keywords may also be included within the meaning of the change over time in the number of related keywords.

The third perspective may be a change over time in a number of new related keywords. The number of the new related keywords is a number of the new related keywords that have become newly related to the analysis target keyword. The number of related keywords that had become related to the analysis target keyword in the previous stage is not included in the number of new related keywords. The change over time in the number of new related keywords can be interpreted broadly. Specifically, the change over time in a rate of increase in the number of new related keywords may also be included within the meaning of the change over time in the number of new related keywords.

The fourth perspective (fourth index), for example, is a change over time in a related field. The related field is a field to which related keywords that are related to the analysis target keywords belong.

A fourth perspective may be a change over time in a number of related fields. The number of related fields is a number of related fields to which the related keywords belong. The change over time in the number of related fields can be interpreted broadly. Specifically, the change over time in a rate of increase in the number of related fields may also be included within the meaning of the change over time in the number of related fields.

The analysis target trend data generation unit 40 generates, based on the results of the aforementioned analysis, the analysis target trend data that quantitatively indicates the trend of the analysis target keyword. Specifically, based on the results of the analysis from the aforementioned four perspectives, the analysis target trend data generation unit 40 generates the analysis target trend data. The analysis target trend data generation unit 40 stores the analysis target trend data, which was generated in this manner, in the storage unit 18. The analysis target trend data that was generated by the analysis target trend data generation unit 40 is stored in the storage unit 18 in a state of being associated with the analysis target keyword.

As noted previously, the information processing device 10 may be equipped with the specific keyword determination unit 44. The specific keyword determination unit 44 determines whether or not the analysis target keyword corresponds to a specific keyword. The specific keyword is a keyword that can be used to predict a trend in the establishment or revision of the laws and regulations or standards. The determination as to whether or not the analysis target keyword is the specific keyword can be performed in the following manner. Specifically, the specific keyword determination unit 44 determines a degree of similarity between the past case trend data and the analysis target trend data. More specifically, by comparing at least a portion of the past case trend data with at least a portion of the analysis target trend data, the specific keyword determination unit 44 determines the degree of similarity between the past case trend data and the analysis target trend data. The past case trend data is data obtained by analyzing from the aforementioned perspectives the past case keyword, which is a keyword related to a past case that led to the enactment or revision of the laws and regulations or standards. More specifically, the past case trend data is data obtained by analyzing from the aforementioned four perspectives the past case keyword, which is a keyword related to a past case that led to the enactment or revision of the laws and regulations or standards. The past case trend data is stored in advance in the past case trend data storage unit 50. In the past case trend data storage unit 50, there can be stored, for example, a plurality of the past case trend data, although the present invention is not necessarily limited to this feature. Artificial intelligence may be used in at least a portion of the specific keyword determination unit 44.

The specific keyword determination unit 44 determines whether or not the degree of similarity between the past case trend data and the analysis target trend data is greater than or equal to the predetermined degree threshold value. In the case that the degree of similarity between the past case trend data and the analysis target trend data is greater than or equal to the predetermined degree threshold value, there is considered to be a high possibility that the analysis target keyword can be used to predict a trend in the establishment or revision of the laws and regulations or standards. Accordingly, in such a case, the specific keyword determination unit 44 determines that the analysis target keyword corresponds to the specific keyword. In the case that the degree of similarity between the past case trend data and the analysis target trend data is less than the predetermined degree threshold value, there is considered to be a low possibility that the analysis target keyword can be used to predict a trend in the establishment or revision of the laws and regulations or standards. Accordingly, in such a case, the specific keyword determination unit 44 does not determine that the analysis target keyword corresponds to the specific keyword. In this manner, based on the past case trend data and the analysis target trend data, the specific keyword determination unit 44 determines whether or not the analysis target keyword corresponds to the specific keyword.

As noted previously, the past case trend data storage unit 50 is capable of storing a plurality of the past case trend data. The specific keyword determination unit 44 is capable of determining that the analysis target keyword corresponds to a specific keyword, in the case that the degree of similarity between any one of the plurality of past case trend data and the analysis target trend data is greater than or equal to the degree threshold value.

The specific keyword acquisition unit 45 acquires the specific keyword identified by the specific keyword determination unit 44. The specific keyword acquisition unit 45 stores the specific keyword that was acquired in the storage unit 18. The specific keyword is stored in the storage unit 18 in a state of being associated with the analysis target trend data. The specific keyword stored in the storage unit 18 is used to predict a trend in the establishment or revision of the laws and regulations or standards. In other words, by searching for information using such a specific keyword, the user can predict a trend in the establishment or revision of the laws and regulations or standards.

As noted previously, the information processing device 10 may be equipped with the storage processing unit 46. In the case that the laws and regulations or standards have been enacted or revised concerning the case related to the analysis target keyword that has been determined by the specific keyword determination unit 44 to correspond to the specific keyword, the storage processing unit 46 carries out the following process. More specifically, in such a case, the storage processing unit 46 stores as the past case trend data in the past case trend data storage unit 50 the analysis target trend data related to the analysis target keyword.

As noted previously, the information processing device 10 may be equipped with the display control unit 48. The display control unit 48 is capable of controlling a screen display of the display unit 22. Artificial intelligence may be used in at least a portion of the display control unit 48.

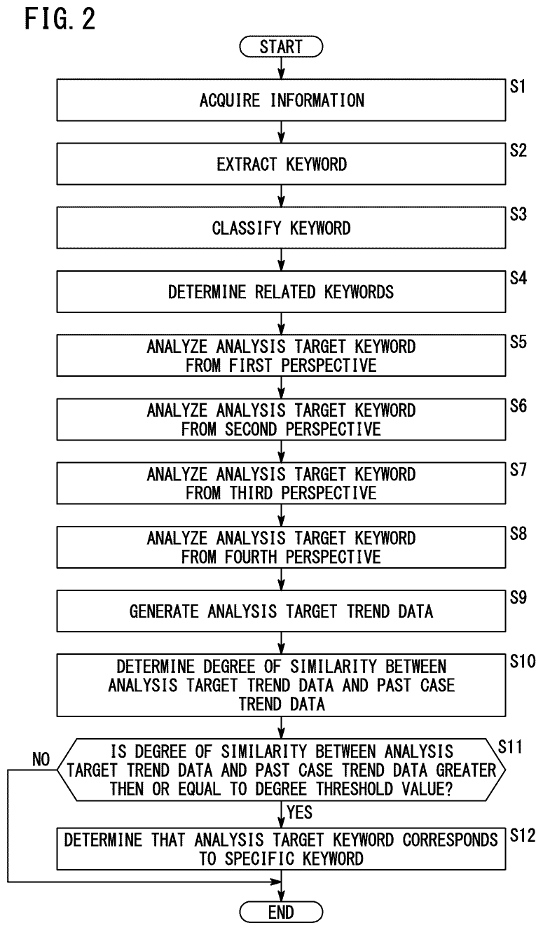

Next, a description will be given with reference to FIG. 2 concerning the information processing method according to the present embodiment. FIG. 2 is a flowchart illustrating an information processing method according to the present embodiment.

In step S1, the information acquisition unit 34 acquires information from the specified site, which is a website specified in advance by a user. Thereafter, the process transitions to step S2.

In step S2, the keyword extraction unit 36 extracts a keyword from the acquired information, which is information acquired by the information acquisition unit 34. Thereafter, the process transitions to step S3.

In step S3, the classification unit 37 determines whether or not the keyword extracted by the keyword extraction unit 36 belongs to any one from within a plurality of fields that are divided in advance. Thereafter, the process transitions to step S4.

In step S4, the related keyword determination unit 38 determines related keywords that are related to the keyword. Thereafter, the process transitions to step S5.

In step S5, the analysis target trend data generation unit 40 analyzes from the first perspective the trend of the analysis target keyword. As noted previously, the first perspective is an elapsed period or a continuous appearance period. As noted previously, the elapsed period is a period from the analysis target keyword having begun to appear within the acquired information. The continuous appearance period is the period during which the analysis target keyword appears continuously within the acquired information. Thereafter, the process transitions to step S6.

In step S6, the analysis target trend data generation unit 40 analyzes from the second perspective the trend of the analysis target keyword. As noted previously, the second perspective is a change in the number of appearances over time. As noted previously, the number of appearances is the number of the analysis target keywords that have appeared within the acquired information. Thereafter, the process transitions to step S7.

In step S7, the analysis target trend data generation unit 40 analyzes from the third perspective the trend of the analysis target keyword. As noted previously, the third perspective is a change over time in the number of the related keywords, or alternatively, is a change over time in the number of new related keywords. As noted previously, the change over time in the number of the related keywords is the number of the related keywords that relate to the analysis target keyword. As noted previously, the number of the new related keywords is the number of the new related keywords that have become newly related to the analysis target keyword. Thereafter, the process transitions to step S8.

In step S8, the analysis target trend data generation unit 40 analyzes from the fourth perspective the trend of the analysis target keyword. As noted previously, the fourth perspective is a change over time in the related fields, or alternatively, is a change over time in the number of the related fields. As noted previously, the related field is a field to which the related keywords belong. As noted previously, the number of related fields is the number of the related fields. Thereafter, the process transitions to step S9.

In step S9, the analysis target trend data generation unit 40 generates, based on the results of the aforementioned analysis, the analysis target trend data that quantitatively indicates the trend of the analysis target keyword.

Thereafter, the process transitions to step S10. In step S10, the specific keyword determination unit 44 determines the degree of similarity between the analysis target trend data and the past case trend data. As noted previously, the past case trend data is data obtained by analyzing from the aforementioned perspectives a past case keyword, which is a keyword related to a past case that led to the enactment or revision of the laws and regulations or standards. As noted previously, the past case trend data storage unit 50 is capable of storing a plurality of the past case trend data. The specific keyword determination unit 44 determines the degree of similarity between each of the plurality of past case trend data and the analysis target trend data. Thereafter, the process transitions to step S11.

In step S11, the specific keyword determination unit 44 determines whether or not a degree of similarity between the analysis target trend data and the past case trend data is greater than or equal to a predetermined degree threshold value. In the case that the degree of similarity between the analysis target trend data and the past case trend data is greater than or equal to the predetermined degree threshold value (YES in step S11), the process transitions to step S12. More specifically, in the case that the degree of similarity between at least one of the plurality of the past case trend data and the analysis target trend data is greater than or equal to the predetermined degree threshold value, the process transitions to step S12. In the case that the degree of similarity between the analysis target trend data and the past case trend data is less than the predetermined degree threshold value (NO in step S11), the process shown in FIG. 2 comes to an end.

In step S12, the specific keyword determination unit 44 determines that the analysis target keyword corresponds to a specific keyword. In this manner, the process shown in FIG. 2 is brought to an end.

The processes shown in steps S5 to S12 are carried out with respect to each of the plurality of analysis target keywords. By the processes shown in steps S5 to S12 being carried out with respect to each of the plurality of analysis target keywords, the specific keyword can be extracted from the plurality of analysis target keywords.

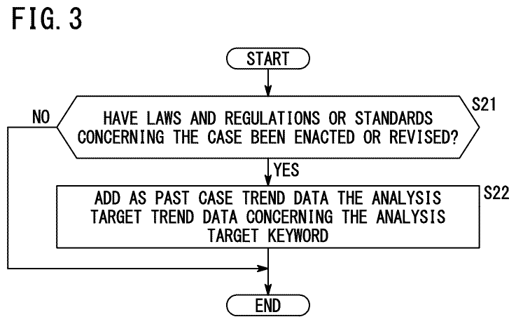

Next, a description will be given with reference to FIG. 3 concerning the information processing method according to the present embodiment. FIG. 3 is a flowchart illustrating an information processing method according to the present embodiment.

In step S21, it is determined by the specific keyword determination unit 44 whether or not the laws and regulations or standards have been enacted or revised concerning a case related to the analysis target keyword that has been determined to correspond to the specific keyword. Whether or not the laws and regulations or standards have been enacted or revised concerning the analysis target keyword may be grasped by the user, although the present invention is not necessarily limited to this feature. In the case that the laws and regulations or standards have been enacted or revised concerning such a case (YES in step S21), the process transitions to step S22. In the case that the laws and regulations or standards have not yet been enacted or revised concerning such a case (NO in step S21), the process shown in FIG. 3 is brought to an end.

In step S22, the storage processing unit 46 stores as the past case trend data in the storage unit 18 the analysis target trend data related to the analysis target keyword. More specifically, the storage processing unit 46 stores as the past case trend data in the past case trend data storage unit 50 the analysis target trend data related to the analysis target keyword. In this manner, the process shown in FIG. 3 is brought to an end.

In this manner, according to the present embodiment, by the trend of the analysis target keyword being analyzed from the predetermined perspectives, the analysis target trend data is generated that quantitatively indicates the trend of the analysis target keyword. Based on the analysis target trend data and the past case trend data, it is determined whether or not the analysis target keyword corresponds to the specific keyword, which is the keyword that can be used to predict the trend in the establishment or revision of the laws and regulations or standards. In the past case trend data, there is also included data of the stage at which a sign of the enactment or revision of the laws and regulations or the like has occurred. Because such past case trend data is used when it is determined whether or not the analysis target keyword corresponds to the specific keyword, the specific keyword can be accurately identified at the stage at which the sign of the enactment or revision of the laws and regulations or the like has occurred. Since the specific keyword can be obtained at the stage at which the sign of the establishment or revision of the laws and regulations or the like has occurred, according to the present embodiment, the establishment or revision of the laws and regulations or the like can be predicted at an early stage. Therefore, according to the present embodiment, it becomes possible to satisfactorily cope with the enactment or revision of the laws and regulations or the like.

### Modified Embodiments

The present invention is not necessarily limited to the embodiment described above, and it goes without saying that various modified or additional configurations could be adopted therein without departing from the essence and gist of the present invention.

For example, in the above-described embodiment, a case has been described as an example in which the trend of the analysis target keyword is analyzed from the first perspective, the second perspective, the third perspective, and the fourth perspective, although the present invention is not necessarily limited to this feature. The analysis target trend data may be generated by analyzing the analysis target keyword from at least one from among the second perspective, the third perspective, and the fourth perspective. Further, the analysis target trend data may be generated by analyzing the analysis target keyword from the first perspective, and at least one from among the second perspective, the third perspective, and the fourth perspective. Further, the analysis target trend data may be generated by analyzing the analysis target keyword from the first perspective, and two from among the second perspective, the third perspective, and the fourth perspective. The analysis target trend data may be generated by analyzing the analysis target keyword from two from among the second perspective, the third perspective, and the fourth perspective. The analysis target trend data may be generated by analyzing the analysis target keyword from the second perspective, the third perspective, and the fourth perspective.

Further, in the above-embodiment, although the detection of a specific keyword that can be used to predict a trend in the establishment or revision of the laws and regulations or standards has been described as an example, the present invention is not necessarily limited to this feature. The present invention is widely applicable to the detection of a specific keyword that enables a trend within the world to be predicted. For example, the present invention can be used to detect a specific keyword that can predict the commercialization of a product or the like.

The inventions that can be grasped from the above-described embodiment will be described below.

The information processing device (10) according to one aspect of the present invention comprises the information acquisition unit (34) that acquires the information from the website at intervals, the keyword extraction unit (36) that extracts the keyword from the information acquired by the information acquisition unit, the analysis target trend data generation unit (40) which, by analyzing from the predetermined perspective the trend of the analysis target keyword which is the keyword that serves as the target of trend analysis, generates the analysis target trend data that quantitatively indicates the trend of the analysis target keyword, and the specific keyword determination unit (44) that determines, based on the past case trend data obtained by analyzing from the perspective the past case keyword, which is the keyword related to the past case that led to the enactment or revision of the laws and regulations or standards, and the analysis target trend data, whether or not the analysis target keyword corresponds to the specific keyword that is usable to predict the trend in the enactment or revision of the laws and regulations or standards. In accordance with such a configuration, by the trend of the analysis target keyword being analyzed from the predetermined perspective, the analysis target trend data is generated that quantitatively indicates the trend of the analysis target keyword. Based on the analysis target trend data and the past case trend data, it is determined whether or not the analysis target keyword corresponds to the specific keyword, which is the keyword that can be used to predict the trend in the enactment or revision of the laws and regulations or standards. In the past case trend data, there is also included the data of the stage at which the sign of the enactment or revision of the laws and regulations or the like has occurred. Because such past case trend data is used when it is determined whether or not the analysis target keyword corresponds to the specific keyword, the specific keyword can be accurately identified at the stage at which the sign of the revision of the laws and regulations or the like has occurred. Since the specific keyword can be obtained at the stage at which the sign of the revision of the laws and regulations or the like has occurred, according to such a configuration, the revision of the laws and regulations or the like can be predicted at an early stage. Therefore, in accordance with such a configuration, it becomes possible to satisfactorily cope with the revision of the laws and regulations or the like.

In the above-described information processing device, the perspective may be at least one from among the second perspective, the third perspective, and the fourth perspective, the second perspective may be the change over time in the number of appearances, which is the number of the analysis target keywords that have appeared within the acquired information, the third perspective may be the change over time in the number of the related keywords, which is the number of the related keywords that relate to the analysis target keyword, or alternatively, may be the change over time in the number of new related keywords, which is the number of the new related keywords that have become newly related to the analysis target keyword, and the fourth perspective may be the change over time in the related field, which is the field to which the related keywords belong, or alternatively, may be a change over time in the number of the related fields, which is the number of the related fields.

In the above-described information processing device, the analysis target trend data generation unit, by analyzing the trend of the analysis target keyword from the plurality of the predetermined perspectives, may generate the analysis target trend data, the specific keyword determination unit may determine, based on the past case trend data obtained by analyzing the past case keyword from the plurality of the perspectives, and the analysis target trend data, whether or not the analysis target keyword corresponds to the specific keyword, the plurality of perspectives may include the first perspective, and at least one from among the second perspective, the third perspective, and the fourth perspective, and the first perspective may be the elapsed period, which is the period from the analysis target keyword having begun to appear within the acquired information, or alternatively, may be the continuous appearance period, which is the period during which the analysis target keyword appears continuously within the acquired information.

In the above-described information processing device, in the case that the degree of similarity between the past case trend data and the analysis target trend data is greater than or equal to the predetermined degree threshold value, the specific keyword determination unit may determine that the analysis target keyword corresponds to the specific keyword.

In the above-described information processing device, there may further be provided the storage processing unit (46) which, in the case that the laws and regulations or standards concerning the case related to one of the analysis target keywords that has been determined by the specific keyword determination unit to correspond to the specific keyword have been established or revised, adds to the storage unit (18) as the past case trend data the analysis target trend data concerning the one of the analysis target keywords. In accordance with such a configuration, since an abundant amount of the past case trend data can be obtained, it is possible to determine with high accuracy whether or not the analysis target keyword corresponds to the specific keyword.

The information processing method according to another aspect of the present invention comprises the acquisition step (step S1) of acquiring the information from the website at intervals, the keyword extraction step (step S2) of extracting the keyword from the information acquired in the acquisition step, the analysis target trend data generation step (step S9) of generating, by analyzing from the predetermined perspective the trend of the analysis target keyword which is the keyword that serves as the target of trend analysis, the analysis target trend data indicating the trend of the analysis target keyword, and the specific keyword determination step (step S12) of determining, based on the past case trend data obtained by analyzing from the perspective the past case keyword, which is the keyword related to the past case that led to the enactment or revision of the laws and regulations or standards, and the analysis target trend data, whether or not the analysis target keyword corresponds to the specific keyword that can be used to predict the trend in the establishment or revision of the laws and regulations or standards.

In the above-described information processing method, the perspective may be at least one from among the second perspective, the third perspective, and the fourth perspective, the second perspective may be the change over time in the number of appearances, which is the number of the analysis target keywords that have appeared within the acquired information, the third perspective may be the change over time in the number of the related keywords, which is the number of the related keywords that relate to the analysis target keyword, or alternatively, may be the change over time in the number of new related keywords, which is the number of the new related keywords that have become newly related to the analysis target keyword, and the fourth perspective may be the change over time in the related field, which is the field to which the related keywords belong, or alternatively, may be a change over time in the number of the related fields, which is the number of the related fields.

In the above-described information processing method, in the analysis target trend data generation step, by analyzing the trend of the analysis target keyword from the plurality of the predetermined perspectives, there may be generated the analysis target trend data, in the specific keyword determination step, there may be determined, based on the past case trend data obtained by analyzing the past case keyword from the plurality of the perspectives, and the analysis target trend data, whether or not the analysis target keyword corresponds to the specific keyword, the plurality of perspectives may include the first perspective, and at least one from among the second perspective, the third perspective, and the fourth perspective, and the first perspective may be the elapsed period, which is the period from the analysis target keyword having begun to appear within the acquired information, or alternatively, may be the continuous appearance period, which is the period during which the analysis target keyword appears continuously within the acquired information.

In the above-described information processing method, in the case that the degree of similarity between the past case trend data and the analysis target trend data is greater than or equal to the predetermined degree threshold value, in the specific keyword determination step, it may be determined that the analysis target keyword corresponds to the specific keyword.

In the above-described information processing method, there may further be provided the storage processing step (step S22) which, in the case that the laws and regulations or standards concerning the case related to one of the analysis target keywords that has been determined in the specific keyword determination step to correspond to the specific keyword have been established or revised, adds to the storage unit as the past case trend data the analysis target trend data concerning the one of the analysis target keywords.

The program according to still another aspect of the present invention causes a computer to perform the acquisition step of acquiring the information from the website at intervals, the keyword extraction step of extracting the keyword from the information acquired in the acquisition step, the analysis target trend data generation step of generating, by analyzing from the predetermined perspective the trend of the analysis target keyword which is the keyword that serves as the target of trend analysis, the analysis target trend data indicating the trend of the analysis target keyword, and the specific keyword determination step of determining, based on the past case trend data obtained by analyzing from the perspective the past case keyword, which is the keyword related to the past case that led to the enactment or revision of the laws and regulations or standards, and the analysis target trend data, whether or not the analysis target keyword corresponds to the specific keyword that can be used to predict the trend in the establishment or revision of the laws and regulations or standards.

In the above-described information program, the perspective may be at least one from among the second perspective, the third perspective, and the fourth perspective, the second perspective may be the change over time in the number of appearances, which is the number of the analysis target keywords that have appeared within the acquired information, the third perspective may be the change over time in the number of the related keywords, which is the number of the related keywords that relate to the analysis target keyword, or alternatively, may be the change over time in the number of new related keywords, which is the number of the new related keywords that have become newly related to the analysis target keyword, and the fourth perspective may be the change over time in the related field, which is the field to which the related keywords belong, or alternatively, may be a change over time in the number of the related fields, which is the number of the related fields.

In the above-described information program, in the analysis target trend data generation step, by analyzing the trend of the analysis target keyword from the plurality of the predetermined perspectives, there may be generated the analysis target trend data, in the specific keyword determination step, there may be determined, based on the past case trend data obtained by analyzing the past case keyword from the plurality of the perspectives, and the analysis target trend data, whether or not the analysis target keyword corresponds to the specific keyword, the plurality of perspectives may include the first perspective, and at least one from among the second perspective, the third perspective, and the fourth perspective, and the first perspective may be the elapsed period, which is the period from the analysis target keyword having begun to appear within the acquired information, or alternatively, may be the continuous appearance period, which is the period during which the analysis target keyword appears continuously within the acquired information.

In the above-described information program, in the case that the degree of similarity between the past case trend data and the analysis target trend data is greater than or equal to the predetermined degree threshold value, in the specific keyword determination step, it may be determined that the analysis target keyword corresponds to the specific keyword.

The above-described program may further cause the computer to perform the storage processing step which, in the case that the laws and regulations or standards concerning the case related to one of the analysis target keywords that has been determined in the specific keyword determination step to correspond to the specific keyword have been established or revised, adds to the storage unit as the past case trend data the analysis target trend data concerning the one of the analysis target keywords.

### REFERENCE SIGNS LIST

10: information processing device
12: network
14: server device
16, 26: computation unit
18, 28: storage unit
20: operation unit
22: display unit
24, 30: communication unit
32, 54: control unit
34: information acquisition unit
36: keyword extraction unit
37: classification unit
38: related keyword determination unit
40: analysis target trend data generation unit
44: specific keyword determination unit
45: specific keyword acquisition unit
46: storage processing unit
48: display control unit
50: past case trend data storage unit

1. An information processing device, comprising:
an information acquisition unit configured to acquire information from a website at intervals;
a keyword extraction unit configured to extract a keyword from the information acquired by the information acquisition unit;
an analysis target trend data generation unit which, by analyzing from a predetermined perspective a trend of an analysis target keyword which is a keyword that serves as a target of trend analysis, is configured to generate analysis target trend data quantitatively indicating a trend of the analysis target keyword; and
a specific keyword determination unit configured to determine, based on past case trend data obtained by analyzing from the perspective a past case keyword, which is a keyword related to a past case that led to the enactment or revision of laws and regulations or standards, and the analysis target trend data, whether or not the analysis target keyword corresponds to a specific keyword that is usable to predict a trend in the enactment or revision of the laws and regulations or standards.

2. The information processing device according to claim 1, wherein:
the perspective is at least one from among a second perspective, a third perspective, and a fourth perspective;
the second perspective is a change over time in a number of appearances, which is a number of the analysis target keywords that have appeared within the acquired information;
the third perspective is a change over time in a number of related keywords, which is a number of the related keywords that relate to the analysis target keyword, or alternatively, is a change over time in a number of new related keywords, which is a number of the new related keywords that have become newly related to the analysis target keyword; and
the fourth perspective is a change over time in a related field, which is a field to which the related keywords belong, or alternatively, is a change over time in a number of the related fields, which is a number of the related fields.

3. The information processing device according to claim 2, wherein:
the analysis target trend data generation unit, by analyzing the trend of the analysis target keyword from a plurality of the predetermined perspectives, generates the analysis target trend data;
the specific keyword determination unit determines, based on the past case trend data obtained by analyzing the past case keyword from a plurality of the perspectives, and the analysis target trend data, whether or not the analysis target keyword corresponds to the specific keyword;
the plurality of perspectives include the first perspective, and at least one from among the second perspective, the third perspective, and the fourth perspective; and
the first perspective is an elapsed period, which is a period from the analysis target keyword having begun to appear within the acquired information, or alternatively, is a continuous appearance period, which is a period during which the analysis target keyword appears continuously within the acquired information.

4. The information processing device according to claim 1, wherein, in the case that the degree of similarity between the past case trend data and the analysis target trend data is greater than or equal to a predetermined degree threshold value, the specific keyword determination unit determines that the analysis target keyword corresponds to the specific keyword.

5. The information processing device according to claim 1, further comprising a storage processing unit which, in the case that laws and regulations or standards concerning a case related to one of the analysis target keywords that has been determined by the specific keyword determination unit to correspond to the specific keyword have been established or revised, is configured to add to the storage unit as the past case trend data the analysis target trend data concerning the one of the analysis target keywords.

6. An information processing method, comprising:
an acquisition step of acquiring information from a website at intervals;
a keyword extraction step of extracting a keyword from the information acquired in the acquisition step;
an analysis target trend data generation step of generating, by analyzing from a predetermined perspective a trend of an analysis target keyword which is a keyword that serves as a target of trend analysis, analysis target trend data quantitatively indicating a trend of the analysis target keyword; and
a specific keyword determination step of determining, based on past case trend data obtained by analyzing from the perspective a past case keyword, which is a keyword related to a past case that led to the enactment or revision of laws and regulations or standards, and the analysis target trend data, whether or not the analysis target keyword corresponds to a specific keyword that is usable to predict a trend in the enactment or revision of the laws and regulations or standards.

7. The information processing method according to claim 6, wherein:
the perspective is at least one from among a second perspective, a third perspective, and a fourth perspective;
the second perspective is a change over time in a number of appearances, which is a number of the analysis target keywords that have appeared within the acquired information;
the third perspective is a change over time in a number of related keywords, which is a number of the related keywords that relate to the analysis target keyword, or alternatively, is a change over time in a number of new related keywords, which is a number of the new related keywords that have become newly related to the analysis target keyword; and
the fourth perspective is a change over time in a related field, which is a field to which the related keywords belong, or alternatively, is a change over time in a number of the related fields, which is a number of the related fields.

8. The information processing method according to claim 7, wherein:
in the analysis target trend data generation step, by analyzing the trend of the analysis target keyword from a plurality of the predetermined perspectives, the analysis target trend data is generated;
in the specific keyword determination step, based on the past case trend data obtained by analyzing the past case keyword from a plurality of the perspectives, and the analysis target trend data, it is determined whether or not the analysis target keyword corresponds to the specific keyword;
the plurality of perspectives include the first perspective, and at least one from among the second perspective, the third perspective, and the fourth perspective; and
the first perspective is an elapsed period, which is a period from the analysis target keyword having begun to appear within the acquired information, or alternatively, is a continuous appearance period, which is a period during which the analysis target keyword appears continuously within the acquired information.

9. The information processing method according to claim 6, wherein, in the specific keyword determination step, in the case that the degree of similarity between the past case trend data and the analysis target trend data is greater than or equal to a predetermined degree threshold value, it is determined that the analysis target keyword corresponds to the specific keyword.

10. The information processing method according to claim 6, further comprising a storage processing step which, in the case that laws and regulations or standards concerning a case related to one of the analysis target keywords that has been determined in the specific keyword determination step to correspond to the specific keyword have been established or revised, adds to the storage unit as the past case trend data the analysis target trend data concerning the one of the analysis target keywords.

11. A non-transitory computer-readable storage medium storing a program causing a computer to perform:
an acquisition step of acquiring information from a website at intervals;
a keyword extraction step of extracting a keyword from the information acquired in the acquisition step;
an analysis target trend data generation step of generating, by analyzing from a predetermined perspective a trend of an analysis target keyword which is a keyword that serves as a target of trend analysis, analysis target trend data quantitatively indicating a trend of the analysis target keyword; and
a specific keyword determination step of determining, based on past case trend data obtained by analyzing from the perspective a past case keyword, which is a keyword related to a past case that led to the enactment or revision of laws and regulations or standards, and the analysis target trend data, whether or not the analysis target keyword corresponds to a specific keyword that is usable to predict a trend in the enactment or revision of the laws and regulations or standards.

12. The non-transitory computer-readable storage medium according to claim 11, wherein:
the perspective is at least one from among a second perspective, a third perspective, and a fourth perspective;
the second perspective is a change over time in a number of appearances, which is a number of the analysis target keywords that have appeared within the acquired information;
the third perspective is a change over time in a number of related keywords, which is a number of the related keywords that relate to the analysis target keyword, or alternatively, is a change over time in a number of new related keywords, which is a number of the new related keywords that have become newly related to the analysis target keyword; and
the fourth perspective is a change over time in a related field, which is a field to which the related keywords belong, or alternatively, is a change over time in a number of the related fields, which is a number of the related fields.

13. The non-transitory computer-readable storage medium according to claim 12, wherein:
in the analysis target trend data generation step, by analyzing the trend of the analysis target keyword from a plurality of the predetermined perspectives, the analysis target trend data is generated;
in the specific keyword determination step, based on the past case trend data obtained by analyzing the past case keyword from a plurality of the perspectives, and the analysis target trend data, it is determined whether or not the analysis target keyword corresponds to the specific keyword;
the plurality of perspectives include the first perspective, and at least one from among the second perspective, the third perspective, and the fourth perspective; and
the first perspective is an elapsed period, which is a period from the analysis target keyword having begun to appear within the acquired information, or alternatively, is a continuous appearance period, which is a period during which the analysis target keyword appears continuously within the acquired information.

14. The non-transitory computer-readable storage medium according to claim 11, wherein, in the specific keyword determination step, in the case that the degree of similarity between the past case trend data and the analysis target trend data is greater than or equal to a predetermined degree threshold value, it is determined that the analysis target keyword corresponds to the specific keyword.

15. The non-transitory computer-readable storage medium according to claim 11, further causing the computer to perform a storage processing step which, in the case that laws and regulations or standards concerning a case related to one of the analysis target keywords that has been determined in the specific keyword determination step to correspond to the specific keyword have been established or revised, adds to the storage unit as the past case trend data the analysis target trend data concerning the one of the analysis target keywords.
